(19) United States
(12) Patent Application Publication
(10) Pub. No.: US 2016/0341846 A1
(43) Pub. Date: Nov. 24, 2016

(54) METHOD AND SYSTEM FOR MEASURING TOTAL EARTH'S MAGNETIC FIELD FOR OCEAN MAGNETIC SURVEY THROUGH ELIMINATION OF GEOMAGNETIC DISTURBANCE AND RECORDING MEDIUM THEREFOR

(71) Applicant: KOREA INSTITUTE OF GEOSCIENCE AND MINERAL RESOURCES (KIGAM), Daejeon (KR)

(72) Inventors: Moo Hee KANG, Daejeon (KR); Kyong-o KIM, Daejeon (KR)

(21) Appl. No.: 14/984,166

(22) Filed: Dec. 30, 2015

(30) Foreign Application Priority Data
May 20, 2015 (KR) 10-2015-0070256

(51) Int. Cl. G01V 3/40; G01V 3/38; G01V 3/165

(52) U.S. Cl. CPC G01V 3/40; G01V 3/165; G01V 3/38

(57) ABSTRACT

Provided are ocean magnetic survey measurement method and system. The ocean magnetic survey measurement method includes a measuring operation for measuring an earth's magnetic field value using a magnetometer according to a heading angle of a probe, which is measured in clockwise direction on a basis of the true north, while the probe moves along a circular path based on a center point in an exploration target area with the magnetometer taken in tow, a data input operation for receiving, by a calculation unit, data for the heading angle of the probe and data for the earth's magnetic field value measured at the heading angle, a calculating operation for setting, by the calculation unit containing a calculation program therein, a magnetic disturbance value induced by the probe, which is included in the measured earth's magnetic field value, and calculating an actual earth's magnetic field value by subtracting the magnetic disturbance value from the measured earth's magnetic field value.

### CROSS-REFERENCE TO RELATED APPLICATION

This application claims priority to Korean Patent Application No. 10-2015-0070256 filed on May 20, 2015 and all the benefits accruing therefrom under 35 U.S.C. §119, the contents of which are incorporated by reference in their entirety.

### BACKGROUND

The present disclosure relates to an ocean magnetic survey for exploring metal natural resources, large-scale geological structures, and pipelines in the sea floor, and more particularly, to a method and system for accurately obtaining a total earth's magnetic field value by correcting distortion, caused by a probe constructed with a metal, in value of magnetic survey measurement at the time of undertaking the ocean magnetic survey, and a computer-readable recording medium with which the method is executable in a computer.

FIG. 1 is a schematic diagram of a view that an ocean magnetic survey is undertaken.

Referring to FIG. 1, typically, an ocean magnetic survey is a method for measuring a total earth's magnetic field with a marine magnetometer taken in tow at the stern of a probe.

The earth's magnetic field is established with about 98% of internal factors caused by liquid metal movement(referring to FIG. 2) in the earth core and remaining about 2% of external factors by the sun. Unlike the earth's gravitational field, the earth's magnetic field continuously varies and such a variation includes a diurnal variation of every day, a secular variation of several hundred or thousand years, and a sudden variation of magnetic storm.

As illustrated in FIG. 3, the earth's magnetic field is represented with a vector having the magnitude and the direction, which is represented with three elements of earth's magnetic field including the total magnetic field F, which is the magnitude of the earth' s magnetic field, a declination D, which is an angle between a horizontal component H of the earth's magnetic field and the true north, and an inclination I that is an angle between H and F. A unit of the earth's magnetic field is nano-Tesla (nT), and values thereof at the equator and poles are respectively about 30,000 nT and 65,000 nT.

TABLE 1
Application fields of magnetic survey (use of
geophysical exploration, Jisu Kim et. al)

```
Positioning
  Pipes, cables, and metal objects
  Embedded military supplies (shells, bombs, etc.)
  Buried metal drums having contaminated or harmful wastes therein
  Shaft or horizontal adit of collapsed mine
Mapping
  Archaeological remains
  Hidden dyke of igneous rock
  Vein containing metals
  Magnetically contrasted geological boundary (stratum etc.) of rock floor
  Large-scale geological structures
```

As shown in Table 1, the magnetic survey has a wide application range from small-scale exploration for searching a pipeline or cable near the surface of the earth to large-scale exploration such as exploration of petroleum resources. As the magnetic survey is frequently used, researches on magnetism of rock or mineral become active. In particular, researches on and applications of residual magnetism of a rock are developed to paleomagnetism, which occupies an important position in geophysics since 1950s, and to be presented as a quantitative evidence for proving main theories of modern geology such as a continent drift theory or a seafloor spreading theory. In addition, in view of industry, they are particularly used for investigating a subsurface structure such as bed rock at the time of exploring petroleum resources and are usefully used together with gravity survey and elastic wave exploration data.

In other words, while the total earth's magnetic field of an exploration target area is measured through the ocean magnetic survey, sudden variation of the earth's magnetic field is determined and elements such as metal cables or pipelines, or metal veins, which influence on the magnetic field, may be explored. Accordingly, it is very important to accurately measure a value of total earth's magnetic field in the ocean magnetic survey. However, since the value measured with marine magnetometer includes a value of magnetic field induced by a probe (manufactured from a ferromagnetic steel material), it is difficult to obtain a pure value of the total earth's magnetic field.

### SUMMARY

The present disclosure provides a method, system, and computer recording medium for measuring a total earth's magnetic field for an ocean magnetic survey through elimination of geomagnetic disturbance, which is capable of accurately measuring the total earth's magnetic field in an exploration target area by eliminating influence of a magnetic field induced by a probe manufactured from a metal material at the time of ocean magnetic survey.

In accordance with an exemplary embodiment of the present invention, a method for measuring a total earth's magnetic field for an ocean magnetic survey, including: a measuring operation for measuring an earth's magnetic field value using a magnetometer according to a heading angle of a probe, which is measured in clockwise direction on a basis of the true north, while the probe moves along a circular path based on a center point in an exploration target area with the magnetometer taken in tow; a data input operation for receiving, by a calculation unit, data for the heading angle of the probe and data for the earth's magnetic field value measured at the heading angle; a calculating operation for setting, by the calculation unit containing a calculation program therein, a magnetic disturbance value induced by the probe, which is included in the measured earth's magnetic field value ; and calculating an actual earth's magnetic field value by subtracting the magnetic disturbance value from the measured earth's magnetic field value.

According to an embodiment, in the calculating operation, the magnetic disturbance value may be calculated by the following Equation (1),

magnetic disturbance value=C₀+C₁ cos θ+C₂ cos 2θ (1)

where θ denotes the heading angle of the probe, which is measured from the true north in clockwise direction, C₀, C₁, and C₂, denote constants according to magnetic characteristics of the probe and distances from the exploration target area and the magnetometer to the probe,
and the calculation program may determine the constants of Equation (1).

According to another embodiment, the calculation program may determine the constants C₀, C₁, and C₂ of Equation (1) of the magnetic disturbance value so as to minimize differences between variations of the earth's magnetic field values continuously measured while the probe moves and changes the heading angle on a basis of an earth's magnetic field value measured at an initial point (the true north direction of the heading angle of 0° of the probe) and each magnetic disturbance value induced by the probe which moves and changes the heading angle.

### BRIEF DESCRIPTION OF THE DRAWINGS

Exemplary embodiments can be understood in more detail from the following description taken in conjunction with the accompanying drawings, in which:

FIG. 1 is a schematic diagram for explaining an ocean magnetic survey;

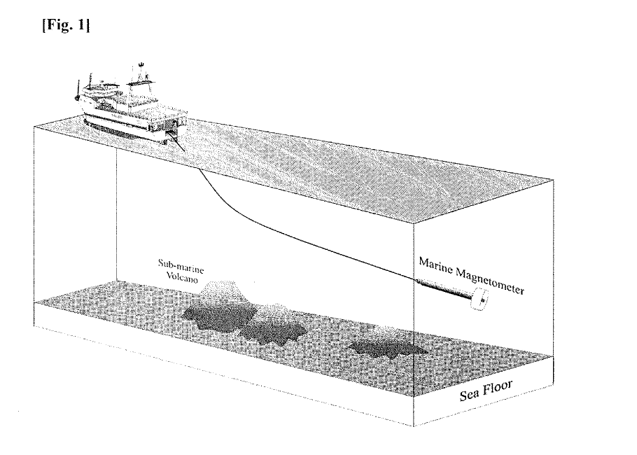

FIG. 2 is a view for explaining constitution of the earth's magnetic field;

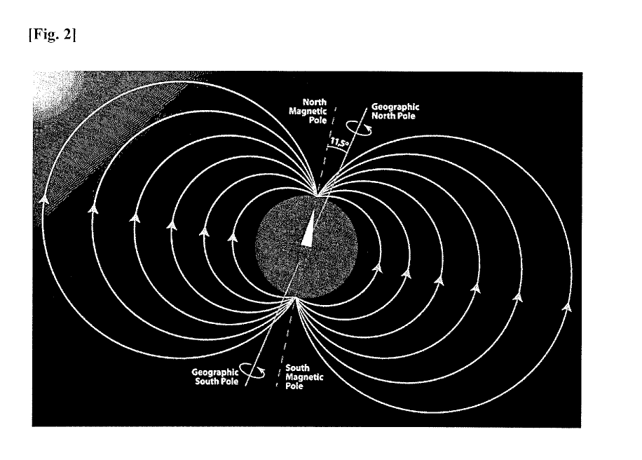

FIG. 3 is a view for explaining three elements of the earth's magnetic field;

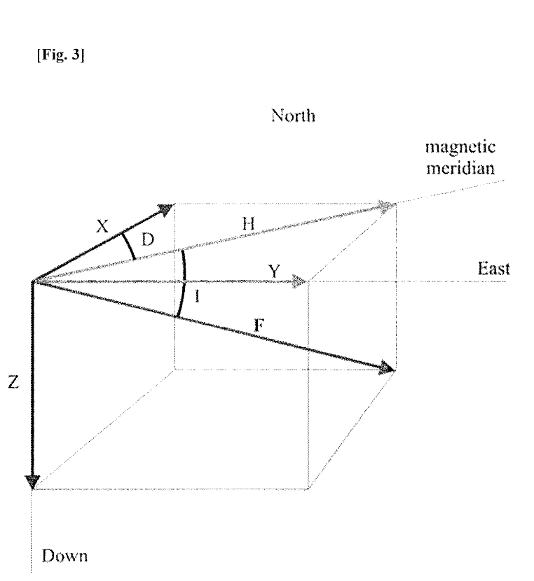

FIG. 4 is a graph representing a total earth's magnetic field measured according to the heading of a probe and a best fit curve of the total earth's magnetic field;

FIG. 5 is a schematic flowchart of a method for measuring the total earth's magnetic field according to the present disclosure;

FIG. 6 is a view for explaining a circular survey;

FIG. 7 is a graph representing a concept of the least squares method;

FIG. 8 is a schematic diagram representing that a Joides Resolution probe vessel undertakes an ocean survey, and

FIG. 9 is a graph representing magnetic field values measured by a magnetometer in an experiment, and a best fit curve formed by using the magnetic field values and an operation program.

### DETAILED DESCRIPTION OF EMBODIMENTS

As described above, it is difficult to determine an accurate value of the total earth's magnetic field in the exploring target area due to an influence of the magnetic field induced by the probe in the ocean magnetic survey. Thus in 1961, Bullard and Mason proposed a method (i.e. the following Equation (1)) for eliminating an influence of a probe from magnetic measurement data, and the present disclosure is based on the Bullard and Mason's method.

F_{Q}=F+C₀+C₁ cos θ+C₂ cos 2θ+S₁ sin θ+S₂ sin 2θ (1)

where F_{Q} denotes a value measured by a marine magnetometer, F denotes a value of a total earth's magnetic field, θ denotes the heading of the probe, which is measured from the north in a clockwise direction, and C₀, C₁, C₂, S₁, and S₂ denote constants according to magnetic characteristics of the probe, and distances from an exploration target area and the magnetometer to the probe.

Here, for a probe having a bilateral symmetry, an influence of sine values is very smaller than that of cosine values, and S₁ and S₂ may be set as 0 (Bullard and Mason, 1961). Accordingly, Equation (1) may be arranged to the following Equation (2).

F_{Q}=F+C₀+C₁ cos θ+C₂ cos 2θ (2)

The underlined part of Equation (2) is caused by a magnetic field induced by the probe, and is an element for distorting a measured value F_{Q} of the earth's magnetic field. Accordingly, once values of C₀, C₁, and C₂, are known, a pure total earth's magnetic field F in an exploring target area may be obtained by eliminating the underlined elements from the measured magnetic field F_{Q}.

‘Bullard and Mason’ proposed a method for eliminating the probe's influence.

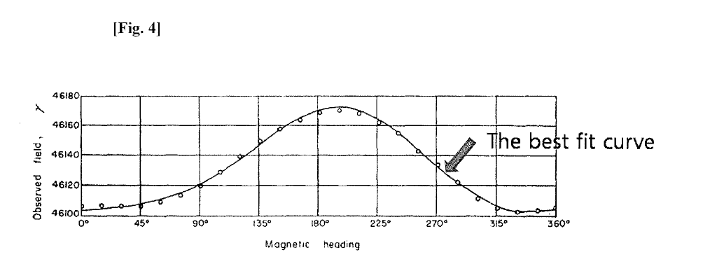

FIG. 4 is a graph representing a total earth's magnetic field measured according to the heading of the probe and a best fit curve of the total earth's magnetic field.

Referring to FIG. 4, the heading direction (a horizontal axis) of the probe is represented as 0 to 360°. In other words, the probe moves along a path of a circle drawn from a specific point and returned thereto. In addition, the earth's magnetic values are measured at each point (a heading angle of the probe) on the path and are represented as points on a vertical axis of the graph. In addition, ‘Bullard and Mason’ suggested that the constants C₀, C₁, and C₂ may be determined by obtaining a best fit curve to the measured values. However, since ‘Bullard and Mason’ did not propose a method for obtaining the best fit curve to the measured values, there is a limitation for using the method.

In the present disclosure, with respect to the measured values, a matrix and a least squares method are introduced to obtain the constants C₀, C₁, and C₂, and through this, the total earth's magnetic field may be accurately measured.

Hereinafter, a description will be provided in detail about a method for measuring a total earth's magnetic field in an ocean magnetic survey through eliminating geomagnetic disturbance (hereinafter, total earth's magnetic field measuring method, total earth's magnetic field measuring system) according to an embodiment of the present disclosure. The total earth's magnetic field measuring method according to the present disclosure may be realized with a time series method, and may he more concretely realized by a computer readable program. Accordingly, the present disclosure is performed by executing a program in a computer in which the program is installed or in a computer using a recording medium on which the program is recorded.

Firstly, the total earth's magnetic field measuring system according to the present disclosure includes a probe, a marine magnetometer, and a calculation unit with a computer program contained therein. As described above, the probe is manufactured from a metal material, and the marine magnetometer is disposed in the sea in a state of being connected to the probe through a wire line. According to movement of the probe, the marine magnetometer is taken in tow and measures a magnetic field value of each point. In addition, magnetic field data obtained by the marine magnetometer is transmitted to the calculation unit by an electrical connection means, and the calculation means calculates a pure value of total earth's magnetic field in an exploration target area by removing an earth's magnetic field distortion element caused by the probe through a calculation algorithm described later.

Using the foregoing system, the total earth's magnetic field measuring method will be described.

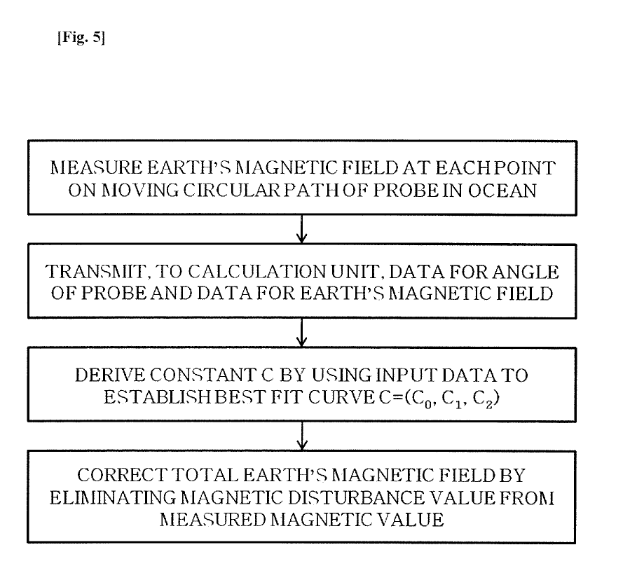

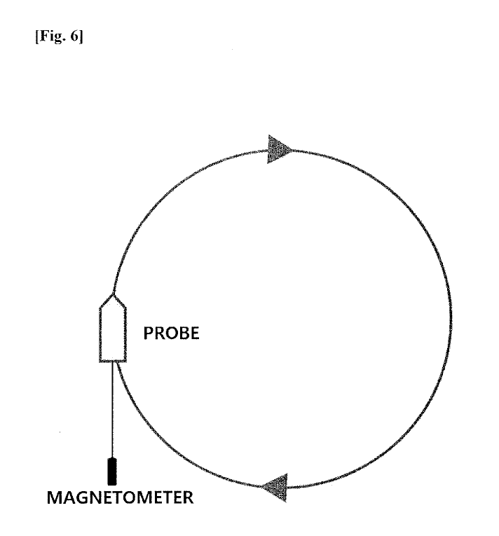

FIG. 5 is a schematic flowchart of the total earth's measuring method according to the present disclosure, and FIG. 6 is a view for explaining a circular survey.

Referring to FIGS. 5 and 6, the total earth's measuring method according to the present disclosure firstly starts from measuring an earth's magnetic field value at each point (or at each heading angle of the probe), while the probe draws a circle in the exploration target area. Regardless of a start direction, the probe draws a circle and measures the magnetic value. The measured data is included in the wire line or is transmitted to the calculation unit through a wired or wireless communication line separated from the wire line.

For the measured data, the calculation unit calculates the constants C₀, C₁, and C₂ for determining the influence of the magnetic field induced by the probe by applying a calculation algorithm according to the present disclosure.

In addition, the pure value F of the total earth's magnetic field in the exploration area may be obtained by removing the influence by the probe from the total earth's magnetic field value F_{Q} that is obtained by substituting the constants to Equation (2).

Hereinafter, the core equation of the calculation program, which is developed by researchers of the present disclosure, is expressed as the following Equation (3) by subtracting a matrix Y from multiplication of matrixes A and C and introducing the least squares method (parts expressed with min and square) and 2-Norm (parts expressed with a subscript of 2 and double absolute value bars).

min∥AC−Y∥²₂ (3)

From Equation (3), a matrix C for the magnetic disturbance constants C₀, C₁, and C₂ may be obtained like the following Equation (4) (detailed procedure will be described later).

C=(A^{T}A)⁻¹·(A^{T}Y) (4)

where a superscript T in Equation (4) denotes a transpose matrix of each matrix. For example, A^{T} is a transpose matrix of a matrix A.

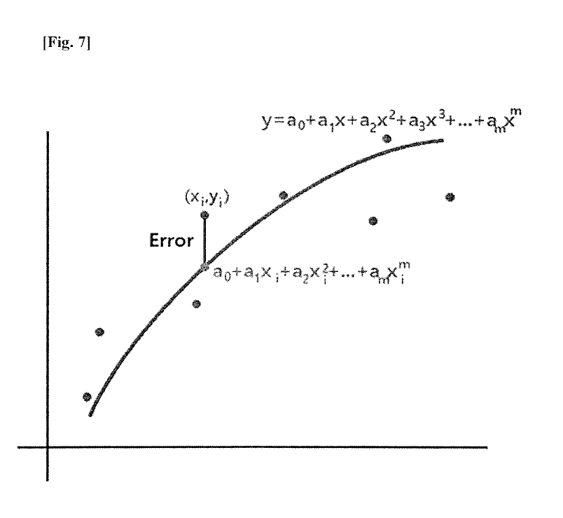

Firstly, concepts of the least squares method and 2-Norm introduced to the calculation program are well-known in Algebra, and therefore they are briefly explained herein. Referring to the graph of FIG. 7, the measured values (red points) and a best fit curve (blue line) to the measured values are expressed with a function y. In addition, errors between actually measured values and function values are represented. The best fit curve to the measured values may be obtained by using the least squares method. Additionally, the researchers combine a mathematical tool of Norm to the least squares method. Norm is for efficiently analyzing an error in numerical solution of an equation.

In other words, when X=(x₁, x₂, x₃ . . . . xₙ), 1-Norm and 2-Norm are defined as the following.

$$1 - Norm \text{:} {‖ x ‖}_{1} = {\sum }_{i = 1}^{n} \vert {x}_{i} \vert$$

$$2 - Norm \text{:} {‖ x ‖}_{2} = {( {\sum }_{i = 1}^{n} {x}_{i}^{2} )}^{1 / 2}$$

1-Norm is a sum of absolute values of each value, and 2-Norm is to put a sum of squares of each value to the power of 1/2. The present calculation program uses 2-Norm.

Equation (9), which is the core of the calculation program employed herein, is derived by defining a difference between the measured magnetic field value and an actual magnetic field value, namely, the value of magnetic field induced by the probe (herein a magnetic disturbance value). In other words, through applying the binominal theorem to Equation (2), the pure value F of magnetic field in the exploration area is subtracted from the actually measured magnetic value F_{Q} to be expressed as the following.

F_{Q}−F=C₀+C₁ cos θ+C₂ cos 2θ

In addition, since values are generated according to the heading direction θ of the probe, a matrix is introduced to express the values as the following.

$$A = ( \begin{matrix}1 , cos {θ}_{1} , cos 2 {θ}_{1} \\ 1 , cos {θ}_{2} , cos 2 {θ}_{2} \\ 1 , cos {θ}_{3} , cos 2 {θ}_{3} \\ 1 , cos {θ}_{4} , cos 2 {θ}_{4} \\ ⋮ \\ 1 , cos {θ}_{n} , cos 2 {θ}_{n}\end{matrix} )$$

$$C = ( \begin{matrix}{C}_{0} \\ {C}_{1} \\ {C}_{2}\end{matrix} )$$

$$Y = ( \begin{matrix}{y}_{1} \\ {y}_{2} \\ {y}_{3} \\ {y}_{4} \\ ⋮ \\ {y}_{n}\end{matrix} )$$

$$A \cdot C = Y$$

(here, when n<3, where n is the number of data measured through the circular survey, C may not exist)

In other words, multiplication A·C of matrixes A and C is a combined expression of a magnetic disturbance value at each point of the circular survey.

In addition, when a total earth's magnetic field value measured at 0° (start point) of the heading direction of the probe is set as a reference, Y may indicate a variation of the total earth's magnetic field value represented according to the probe's heading direction. In other words, since the probe does not move when the heading thereof is at 0°, the actually measured value F_{Q} by the magnetometer may be considered as a pure value that is not influenced by the magnetic disturbance value caused by the probe. In addition, as the probe changes the heading thereof and moves, a variation value F_{Q}−F₀ of the actually measured earth's magnetic field may be considered as the magnetic disturbance value yₙ occurred by the probe.

yₙ=F_{Q}−F₀=C₀+C₁ cos θ+C₂ cos 2θ

Accordingly, a matrix function AC−Y for which the matrix Y is subtracted from the multiplication AC of the matrixes A and C is set. For the value of AC−Y, the least squares method and 2-Norm are introduced to set [min∥AC−Y∥²₂] like Equation (3), and the matrix C for minimizing the value of Equation (3) is obtained.

Obtaining a solution of the matrix C for minimizing Equation (3) means that the best fit curve to the actually measured values may be obtained.

Hereinafter, a procedure for obtaining the solution of matrix C will be described.

From the matrix of Equation (3), the 2-Norm and squares may be expressed as the following.

$$\begin{matrix}min {‖ AC - Y ‖}_{2}^{2} = {min ( A C - Y )}^{T} ( A C - Y ) \\ = min [ \begin{matrix}{( A C )}^{T} ( A C ) - {( A C )}^{T} Y - \\ {Y}^{T} ( A C ) + {Y}^{T} Y\end{matrix} ] \\ = min ( {C}^{T} {A}^{T} A C - 2 {C}^{T} {A}^{T} Y + {Y}^{T} Y )\end{matrix} \qquad Intermediate equation ( 1 )$$

In the intermediate equation (1), the superscript T denotes a transpose matrix.

Accordingly, in the intermediate equation (1), C^{T}A^{T}AC−2C^{T}A^{T}Y+Y^{T}Y may be changed to C²A²−2CAY+Y². This is because the transpose matrix is just to transpose rows and columns of a matrix and an absolute value thereof is identical.

In order to obtain the matrix C, the following intermediate equation (2) is derived from the intermediate equation (1) through partial differentiation.

∇(C^{T}A^{T}AC−2C^{T}A^{T}Y+Y^{T}Y)C=2A^{T}AC−2A^{T}Y=0 intermediate equation (2)

In other words, partially differentiating C²A²−2CAY+Y² with respect to C becomes 2CA²−2AY. However, since a sequence change is not allowed in the matrix operation, the intermediate equation (2) is arranged in that order.

Accordingly, the following Equation (4) may be derived by solving the intermediate equation (2) of 2A^{T}AC−2A^{T}Y=0 with respect to C. Equation (4) is like the following.

C=(A^{T}A)⁻¹·(A^{T}Y) (4)

where (ATA)⁻¹ is an inverse matrix of A^{T}A, Y denotes a variation Δ of the total magnetic field measured along the heading of the probe, when the total magnetic field value measured at 0° of the probe's heading is set as a reference.

Accordingly, by solving Equation (4), the solution (C₀, C₁, C₂) of the matrix C may be obtained. The calculation unit, which is an element of the present disclosure, contains Equation (4), and when data is input, calculation for obtaining the solution of matrix C is performed.

When the solution of the matrix is obtained, since the magnetic disturbance value (C₀+C₁ cos θ+C₂ cos 2θ) induced by the probe may be known, the pure value of total magnetic value in the exploration target area may be calculated by subtracting the magnetic disturbance value from the actually measured total magnetic field value at each heading of the probe.

In other words, in the present disclosure, it is set (AC−Y=0) that there is no influence of disturbance magnetic field induced by the probe by selecting the total magnetic field value measured at a initial start time (a heading angle 0° of the probe) of the probe as an actual magnetic value. Thereafter, a solution for the matrix C is obtained for minimizing a difference between total magnetic field values Y (Y values actually mean a variation from the start time, since it is set that AC−Y=0 at the start time) measured while the probe moves. Once the solution of the matrix C is obtained, since the disturbance magnetic field value induced by the probe is capable of being calculated, the actual total magnetic field value may be accurately calculated by subtracting the magnetic disturbance value from the actually measured total magnetic value.

Hereinafter, an example of a procedure for mathematically obtaining the matrix C of Equation (4) will be described. In order to avoid mathematical complexity, the procedure is simplified with values measured at four angles θ₁, θ₂, θ₃, and θ₄. The operation is performed as the following four steps of STEP 1 to 4.

STEP1: A^{T}A (here, A^{T} is a transpose matrix of A)

$${A}^{T} = ( \begin{matrix}1 , & 1 , & 1 , & 1 \\ cos {θ}_{1} , & cos {θ}_{2} , & cos {θ}_{3} , & cos {θ}_{4} \\ cos 2 {θ}_{1} , & cos 2 {θ}_{2} , & cos 2 {θ}_{3} , & cos 2 {θ}_{4}\end{matrix} )$$

$$A = ( \begin{matrix}1 \\ 1 \\ 1 \\ 1\end{matrix} \begin{matrix}cos {θ}_{1} \\ cos {θ}_{2} \\ cos {θ}_{3} \\ cos {θ}_{4}\end{matrix} \begin{matrix}cos 2 {θ}_{1} \\ cos 2 {θ}_{2} \\ cos 2 {θ}_{3} \\ cos 2 {θ}_{4}\end{matrix} )$$

$${A}^{T} A = ( \begin{matrix}{A}_{11} , & {A}_{12} , & {A}_{13} \\ {A}_{21} , & {A}_{22} , & {A}_{23} \\ {A}_{31} , & {A}_{32} , & {A}_{33}\end{matrix} )$$

$${A}_{11} = 1 \times 1 + 1 \times 1 + 1 \times 1 + 1 \times 1$$

$${A}_{22} = cos {θ}_{1} cos {θ}_{1} + cos {θ}_{2} cos {θ}_{2} + cos {θ}_{3} cos {θ}_{3} + cos {θ}_{4} cos {θ}_{4}$$

$${A}_{33} = cos 2 {θ}_{1} cos 2 {θ}_{1} + cos 2 {θ}_{2} cos 2 {θ}_{2} + cos 2 {θ}_{3} cos 2 {θ}_{3} + cos 2 {θ}_{4} cos 2 {θ}_{4}$$

Aᵢⱼ=value that horizontal components of AT are respectively multiplied by vertical components of A and summed

STEP2: obtain (A^{T}A)⁻¹ (i.e. inverse matrix of A^{T}A)
When

$${A}^{T} A = ( \begin{matrix}{A}_{11} , & {A}_{12} , & {A}_{13} \\ {A}_{21} , & {A}_{22} , & {A}_{23} \\ {A}_{31} , & {A}_{32} , & {A}_{33}\end{matrix} ) ,$$

(A^{T}A)⁻¹may be expressed as the following by the inverse matrix theorem.

$${( {A}^{T} A )}^{- 1} = \frac{1}{\begin{matrix}{A}_{11} ( {A}_{22} {A}_{33} - {A}_{23} {A}_{32} ) - {A}_{12} ( {A}_{21} {A}_{33} - {A}_{23} {A}_{31} ) + \\ {A}_{13} ( {A}_{21} {A}_{32} - {A}_{22} {A}_{31} )\end{matrix}} ( \begin{matrix}{A}_{22} {A}_{33} - {A}_{23} {A}_{32} , & {A}_{13} {A}_{32} - {A}_{12} {A}_{33} , & {A}_{12} {A}_{33} - {A}_{13} {A}_{22} \\ {A}_{23} {A}_{31} - {A}_{21} {A}_{33} , & {A}_{11} {A}_{33} - {A}_{13} {A}_{31} , & {A}_{13} {A}_{21} - {A}_{11} {A}_{23} \\ {A}_{21} {A}_{32} - {A}_{22} {A}_{31} , & {A}_{12} {A}_{31} - {A}_{11} {A}_{31} , & {A}_{11} {A}_{22} - {A}_{12} {A}_{21}\end{matrix} ) = ( \begin{matrix}{B}_{11} , & {B}_{12} , & {B}_{13} \\ {B}_{21} , & {B}_{22} , & {B}_{23} \\ {B}_{31} , & {B }_{32} , & {B}_{33}\end{matrix} )$$

STEP3: obtain A^{T}Y

$${A}^{T} = ( \begin{matrix}1 , & 1 , & 1 , & 1 \\ cos {θ}_{1} , & cos {θ}_{2} , & cos {θ}_{3} , & cos {θ}_{4} \\ cos 2 {θ}_{1} , & cos 2 {θ}_{2} , & cos 2 {θ}_{3} , & cos 2 {θ}_{4}\end{matrix} )$$

$$Y = ( \begin{matrix}{y}_{1} \\ {y}_{2} \\ {y}_{3} \\ {y}_{4}\end{matrix} ) \\$$

$${A}^{T} Y = ( \begin{matrix}y 1 + y 2 + y 3 + y 4 \\ cos θ 1 * y 1 + cos θ 2 * y 2 + cos θ 3 * y 3 + cos θ 4 * y 4 \\ cos 2 θ 1 * y 1 + cos 2 θ 2 * y 2 + cos 2 θ 3 * y 3 + cos 3 θ 4 * y 4\end{matrix} ) = {( \begin{matrix}{D}_{1} \\ {D}_{2} \\ {D}_{3}\end{matrix} )}_{+}$$

STEP4: substitute (A^{T}A)⁻¹·A^{T}Y

$$\begin{matrix}C = {( {A}^{T} A )}^{- 1} \cdot ( {A}^{T} Y ) \\ = ( \begin{matrix}{B}_{11} , & {B}_{12} , & {B}_{13} \\ {B}_{21} , & {B}_{22} , & {B}_{23} \\ {B}_{31} , & {B}_{32} , & {B}_{33}\end{matrix} ) * ( \begin{matrix}{D}_{1 } \\ {D}_{2} \\ {D}_{3}\end{matrix} ) \\ = ( \begin{matrix}{B}_{11} * {D}_{1} + {B}_{12} * {D}_{2} + {B}_{13} * {D}_{3} \\ {B}_{21} * {D}_{1} + {B}_{22} * {D}_{2} + {B}_{23} * {D}_{3} \\ {B}_{31} * {D}_{1} + {B}_{32} * {D}_{2} + {B}_{33} * {D}_{3}\end{matrix} ) \\ = ( \begin{matrix}{C}_{0} \\ {C}_{1} \\ {C}_{2}\end{matrix} )\end{matrix}$$

At this point, matrix

$$( \begin{matrix}{B}_{11} , & {B}_{12} , & {B}_{13} \\ {B}_{21} , & {B}_{22} , & {B}_{23} \\ {B}_{31} , & {B}_{32} , & {B}_{33}\end{matrix} ) = \frac{1}{\begin{matrix}{A}_{11} ( {A}_{22} {A}_{33} - {A}_{23} {A}_{32} ) - {A}_{12} ( {A}_{21} {A}_{33} - {A}_{23} {A}_{31} ) + \\ {A}_{13} ( {A}_{21} {A}_{32} - {A}_{22} {A}_{31} )\end{matrix}} ( \begin{matrix}{A}_{22} {A}_{33} - {A}_{23} {A}_{32} , & {A}_{13} {A}_{32} - {A}_{12} {A}_{33} , & {A}_{12} {A}_{33} - {A}_{13} {A}_{22} \\ {A}_{23} {A}_{31} - {A}_{21} {A}_{33} , & {A}_{11} {A}_{33} - {A}_{13} {A}_{31} , & {A}_{13} {A}_{21} - {A}_{11} {A}_{23} \\ {A}_{21} {A}_{32} - {A}_{22} {A}_{31} , & {A}_{12} {A}_{31} - {A}_{11} {A}_{31} , & {A}_{11} {A}_{22} - {A}_{12} {A}_{21}\end{matrix} )$$

and matrix

$$( \begin{matrix}{D}_{1} \\ {D}_{2} \\ {D}_{3}\end{matrix} ) = ( \begin{matrix}y 1 + y 2 + y 3 + y 4 \\ cos θ 1 * y 1 + cos θ 2 * y 2 + cos θ 3 * y 3 + cos θ 4 * y 4 \\ cos 2 θ 1 * y 1 + cos 2 θ 2 * y 2 + cos 2 θ 3 * y 3 + cos 3 θ 4 * y 4\end{matrix} )$$

As described above, the calculation unit may receive data for the heading angle θ of the probe and data for magnetic values measured at each angle, solve the above-described matrixes to obtain the magnetic disturbance constants C(C₀, C₁, C₂) and may obtain the magnetic disturbance value induced by the probe. In addition, an actual magnetic field value in the exploration target area may be accurately determined by subtracting the magnetic disturbance value from the actually measured magnetic value.

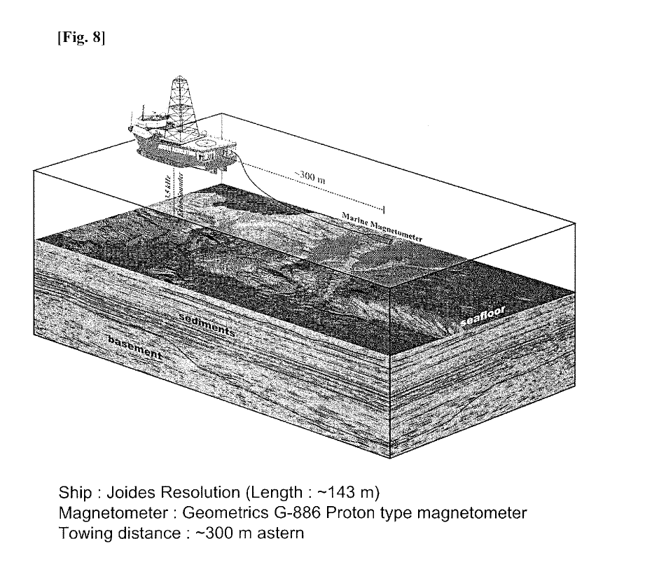

The researchers of the present disclosure performed experiments in order to investigate effects of the total magnetic field measuring method and calculation program. FIG. 8 is a schematic diagram representing that a Joides Resolution probe vessel undertakes an ocean survey.

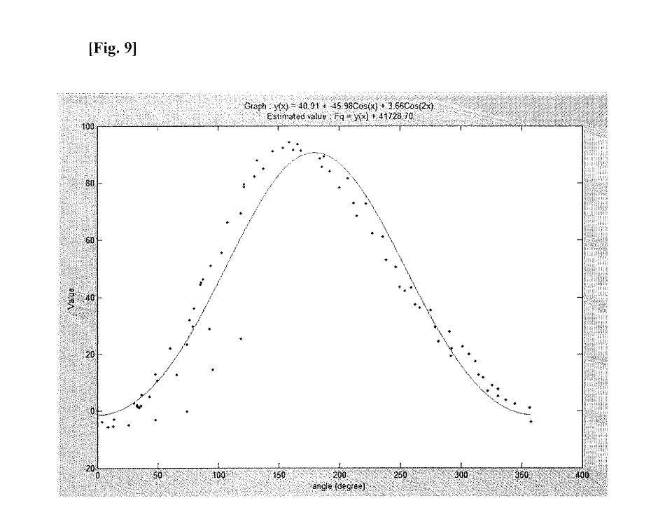

As illustrated in FIGS. 8, a circular survey was performed in an area of “Ori Massif” by using a probe vessel of “Joides Resolution”. In the experiment, the magnetic field value measured by the magnetometer and a best fit curve formed by the present calculation program were represented in FIG. 9.

Through the above-described experiment, a magnetic survey was performed by using the vessel of “Joides Resolution” in area of “Ori Massif” and magnetic disturbance constants C(C₀, C₁, C₂) were obtained as the following by using the calculation program, and the disturbance magnetic field value F_{H} by the probe vessel was obtained.

F_{H}=C₀+C₁ cos θ+C₂ cos 2θ=40.91−45.89 cos θ+3.66 cos2θ

Referring to FIG. 9, as a result of deriving a best fit curve by determining a constant value C with the calculation program, it is shown that the actually measured value (points on the graph) and the best fit curve are almost matched.

The following Table 2 and Table 3 show results of cross-over error comparison before and after correction of the magnetic disturbance caused by the probe with the present calculation program in the above-described experiment.

TABLE 2
Cross-over error before correction of magnetic disturbance

| xcoord | ycoord | XOE | RefLine | RefCnt | RefVal | CmpLine | CmpCnt | CmpVal | WAveVal |
|---|---|---|---|---|---|---|---|---|---|
| 158.8044778 | 36.1067347 | 6.6 | EXP324-L5T | 87 | 41730.8 | EXP324-L5T | 159 | 41724.1 | 41727.5 |
| 158.8058571 | 36.1085933 | 5.7 | EXP324-L5T | 88 | 41731.2 | EXP324-L5T | 160 | 41725.5 | 41728.4 |
| 158.8825014 | 36.0945155 | 48.2 | EXP324-L5T | 117 | 41817.7 | EXP324-L5T | 182 | 41769.5 | 41793.6 |

Before Correct: Num of XOPs = 3, Mean XOE = 20.2, RMS XOE = 20.2, Max XOE = 48.2, Min XOE = 5.7

Before the correction of magnetic disturbance, it shows an average error of 20.2 nT, a maximum error of 48.2 nT, and a minimum error of 5.7 nT.

TABLE 3
Cross-over error after correction of magnetic disturbance

| xcoord | ycoord | XOE | RefLine | RefCnt | RefVal | CmpLine | CmpCnt | CmpVal | WAveVal |
|---|---|---|---|---|---|---|---|---|---|
| 158.8044778 | 36.1067347 | 6.5 | EXP324-L5T | 87 | 41726.9 | EXP324-L5T | 159 | 41720.4 | 41723.7 |
| 158.8058571 | 36.1085933 | 12.1 | EXP324-L5T | 88 | 41728.0 | EXP324-L5T | 160 | 41715.9 | 41721.9 |
| 158.8825014 | 36.0945155 | −0.1 | EXP324-L5T | 117 | 41727.5 | EXP324-L5T | 182 | 41727.5 | 41727.5 |

Before Correct: Num of XOPs = 3, Mean XOE = 6.2, RMS XOE = 6.2, Max XOE = 12.1, Min XOE = −0.1

After the correction of magnetic disturbance, it shows an average error of 6.2 nT, a maximum error of 12.1 nT, and a minimum error of −0.1 nT. In other words, as a result of performing the correction with the present calculation program, it may be seen that an error range is remarkably reduced. This means that when the circular survey is performed and the calculation program is executed according to the present disclosure, an influence of the disturbance magnetic field induced by the probe is minimized in an ocean magnetic survey to enable a reliable magnetic survey.

In particular, the present disclosure is not applied only to a specific magnetometer, but is useable to all magnetometers regardless of types thereof. Furthermore, even an area where the exploration is already performed, when there are magnetic field measurement values according to a heading angle of the probe, correction therefor may be possible through post-processing data by executing the present calculation program.

According to the method and system for measuring a total earth's magnetic field in the ocean magnetic survey, when a magnetic survey is undertaken by using a vessel in an exploration target area, the value of total earth's magnetic field in the exploration target area may be accurately measured by removing an influence of the magnetic field induced by the vessel.

In addition, post-processing correction for the magnetic survey data is possible by using already measured data, even when the exploration is completed.

In addition, the system and method according to the present disclosure may be applied to all the magnetometers used for magnetic survey regardless of a type thereof.

Although the method and system for measuring total earth's magnetic field in ocean magnetic survey through elimination of geomagnetic disturbance and Recording medium therefor have been described with reference to the specific embodiments, they are not limited thereto. Therefore, it will be readily understood by those skilled in the art that various modifications and changes can be made thereto without departing from the spirit and scope of the present invention defined by the appended claims.

1. A method for measuring a total earth's magnetic field for an ocean magnetic survey, the method comprising:
a measuring operation for measuring an earth's magnetic field value using a magnetometer according to a heading angle of a probe, which is measured in clockwise direction on a basis of the true north, while the probe moves along a circular path based on a center point in an exploration target area with the magnetometer taken in tow;
a data input operation for receiving, by a calculation unit, data for the heading angle of the probe and data for the earth's magnetic field value measured at the heading angle;
a calculating operation for setting, by the calculation unit containing a calculation program therein, a magnetic disturbance value induced by the probe, which is comprised in the measured earth's magnetic field value;
calculating an actual earth's magnetic field value by subtracting the magnetic disturbance value from the measured earth's magnetic field value; and
the magnetic disturbance value in the calculating operation is calculated by the following Equation (1),
magnetic disturbance value=C₀+C₁ cos θ+C₂ cos 2θ (1)
where θ denotes the heading angle of the probe, which is measured from the true north in clockwise direction, C₀, C₁, and C₂, denote constants according to magnetic characteristics of the probe and distances from the exploration target area and the magnetometer to the probe,
and the calculation program determines the constants of Equation (1).

2. (canceled)

3. The method of claim 1, wherein the calculation program determines the constants C₀, C₁, and C₂ of Equation (1) so as to minimize differences between variations of the earth's magnetic field values continuously measured while the probe moves and changes the heading angle on a basis of an earth's magnetic field value measured at an initial point (the true north direction of the heading angle of 0° of the probe) and each magnetic disturbance value induced by the probe which moves and changes the heading angle.

4. The method of claim 1, wherein the calculation program determines the constants C₀, C₁, and C₂ by calculating the following matrix of Equation (2),
C=(A^{T}A)⁻¹·(A^{T}Y) (2)
where a matrix A, expressed as the following, denotes a matrix having the heading angle of the probe as a variable, a matrix C denotes a matrix for the constant values of Equation (1), Y denotes variations of the earth's magnetic field values continuously measured while the probe moves and changes the heading angle on a basis of the earth's magnetic field value actually measured by the probe or an earth's magnetic field value measured at an initial time (the heading angle of 0° of the probe), a superscript T denotes a transpose matrix, and a superscript −1 denotes an inverse matrix.
$$A = ( \begin{matrix}1 , cos {θ}_{1} , cos 2 {θ}_{1} \\ 1 , cos {θ}_{2} , cos 2 {θ}_{2} \\ 1 , cos {θ}_{3} , cos 2 {θ}_{3} \\ 1 , cos {θ}_{4} , cos 2 {θ}_{4} \\ ⋮ \\ 1 , cos {θ}_{n} , cos 2 {θ}_{n}\end{matrix} )$$
$$C = ( \begin{matrix}{C}_{0} \\ {C}_{1} \\ {C}_{2}\end{matrix} )$$
$$Y = ( \begin{matrix}{y}_{1} \\ {y}_{2} \\ {y}_{3} \\ {y}_{4} \\ ⋮ \\ {y}_{n}\end{matrix} )$$
$$A \cdot C = Y$$
(here, when n<3, where n is the number of data measured through the circular survey, C may not exist)

5. The method of claim 4, where Equation (2) is derived from the following Equation (3) which introduces mathematical tools of “least squares method” and “2-Norm”.
min∥AC−Y∥²₂ (3)

6. A system for measuring a total earth's magnetic field for an ocean magnetic survey, the system comprising:
a probe operated in water;
a magnetometer which is connected to the probe through a wire line and is taken in tow by the probe and which measures an earth's magnetic field in an exploration target area; and
a calculation unit receiving, from the magnetometer, data for the measured earth's magnetic field and a heading angle of the probe and containing therein a computer readable calculation program for calculating a magnetic disturbance value induced by the probe,
wherein the calculation program performs the calculating operation in any one of claims 1, 3 and 4.
